(19) United States
(12) Patent Application Publication
(10) Pub. No.: US 2026/0187983 A1
(43) Pub. Date: Jul. 2, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Chun Yang TAN, Tokyo (JP); Yasunori Babazaki, Tokyo (JP)

(73) Assignee: NEC Corporation, Tokyo (JP)

(21) Appl. No.: 19/420,974

(22) Filed: Dec. 16, 2025

(30) Foreign Application Priority Data
Dec. 26, 2024 (JP) 2024-230084

(51) Int. Cl. G06V 10/77; G06V 10/24; G06V 10/40; G06V 10/74; G06V 10/764; G06V 10/82; G06V 20/40; G06V 30/16; G06V 30/18; G06V 30/19; G06V 40/20

(52) U.S. Cl. CPC G06V 10/7715; G06V 10/248; G06V 10/40; G06V 10/761; G06V 10/764; G06V 20/41; G06V 30/1613; G06V 30/19093; G06V 40/20; G06V 10/82; G06V 30/18152

(57) ABSTRACT

In the information processing device, the visual feature extraction unit extracts visual features from object visual information. The text feature extraction unit extracts text features from a text related to the visual features. The feature adjustment unit performs feature alignment of the text features and the visual features based on a mutual relationship between the text features and the visual features.

### INCORPORATION BY REFERENCE

This application is based upon and claims the benefit of priority from Japanese Patent Application 2024-230084, filed on Dec. 26, 2024, the disclosure of which is incorporated herein in its entirety by reference.

### TECHNICAL FIELD

The present disclosure relates to a technology for associating visual information with a text.

### BACKGROUND ART

There is known a technology for determining relation between an image and a text by extracting an image feature from the image, extracting a text feature from the text, and comparing the image feature and the text feature. For example, JP 2022-180958 describes a method of training a model in such a way as to embed a sentence indicating content of an image and the image in association with each other in a common space, and searching for an image by using the model.

### SUMMARY

In order to accurately determine relation and similarity between an image and a text, it is needed to accurately embed an image feature and a text feature in the same feature space.

One object of the present disclosure is to provide an information processing device capable of accurately determining relation between an image and a text.

According to an example aspect of the present invention, there is provided an information processing device comprising:
a visual feature extraction means configured to extract visual features from visual information;
a text feature extraction means configured to extract text features from a text related to the visual features; and
a feature adjustment means configured to perform feature alignment of the text features and the visual features based on a mutual relationship between the text features and the visual features.

According to another example aspect of the present invention, there is provided a information processing method executed by a computer, the information processing method comprising:
extracting visual features from visual information;
extracting text features from a text related to the visual features; and
performing feature alignment of the text features and the visual features based on a mutual relationship between the text features and the visual features.

According to still another example aspect of the present invention, there is provided a program for causing a computer to execute processing comprising:
extracting visual features from visual information;
extracting text features from a text related to the visual features; and
performing feature alignment of the text features and the visual features based on a mutual relationship between the text features and the visual features.

According to the present disclosure, an image and a text can be accurately associated with each other.

### BRIEF DESCRIPTION OF THE DRAWINGS

FIG. 1 illustrates an overall configuration of an information processing device according to an example of the present disclosure;

FIG. 2 is a block diagram illustrating a hardware configuration of the information processing device;

FIG. 3 is a block diagram illustrating a functional configuration of the information processing device;

FIG. 4 illustrates an example of classification by a classification unit;

FIGS. 5A and 5B illustrate block diagrams of variations of a feature adjustment block;

FIGS. 6A and 6B illustrate block diagrams of variations of the feature adjustment block;

FIG. 7 illustrates a configuration example of a mutual feature adjustment unit;

FIG. 8 is a block diagram illustrating a specific example of the mutual feature adjustment unit;

FIG. 9 illustrates a flowchart of processing by the mutual feature adjustment unit;

FIG. 10 illustrates a variation of the mutual feature adjustment unit;

FIGS. 11A and 11B illustrate variations of the mutual feature adjustment unit;

FIG. 12 illustrates a configuration of the information processing device at the time of training;

FIG. 13 is a flowchart of classification processing;

FIG. 14 illustrates a result of five-class classification by the information processing device;

FIG. 15 illustrates distributions of features on a feature space in a comparative example and a proposed method;

FIG. 16 illustrates an example of an action management system to which the information processing device is applied;

FIG. 17 is a block diagram illustrating a functional configuration of another information processing device; and

FIG. 18 is a flowchart of processing by the another information processing device.

### EXAMPLE EMBODIMENTS

### First Example Embodiment

### Overall Configuration

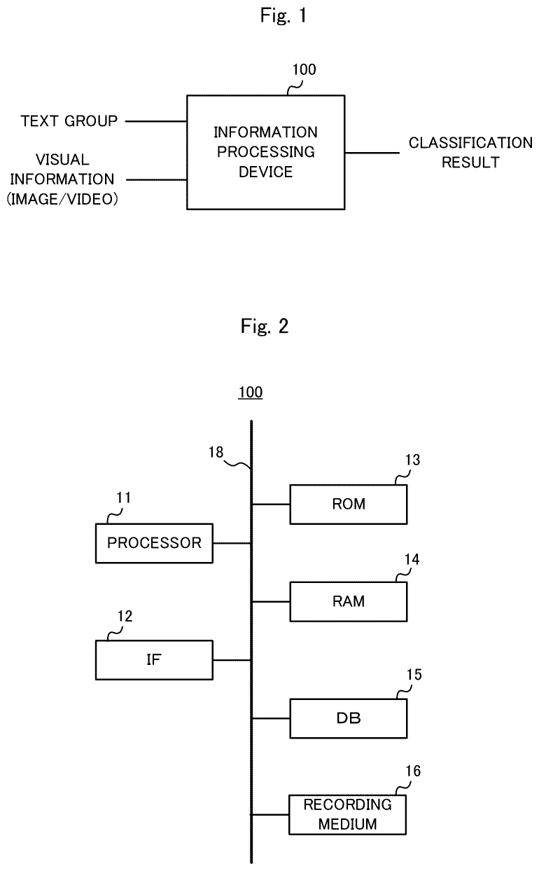

FIG. 1 illustrates an overall configuration of an information processing device according to an example embodiment of the present disclosure. An information processing device 100 associates input visual information and text with each other. Specifically, the information processing device 100 determines a text related to input visual information among a plurality of texts included in an input text group. The visual information may be an image (still image) or a video (moving image).

The visual information captured by a camera or the like is input to the information processing device 100. To the information processing device 100, the visual information may be directly input from the camera, or visual information accumulated in a database or the like may be input. The text group related to content of the visual information is input to the information processing device 100.

In one example, the visual information is information obtained by capturing a state where a person is performing some action, and the text group includes an action name indicating the action of the person, an explanatory sentence of the action, and the like. In this case, the information processing device 100 outputs, as a classification result, a text indicating the action of the person included in the visual information.

### Hardware Configuration

FIG. 2 is a block diagram illustrating a hardware configuration of the information processing device 100. As illustrated, the information processing device 100 includes a processor 11, an interface (IF) 12, a read only memory (ROM) 13, a random access memory (RAM) 14, a database (DB) 15, and a recording medium 16. The components are connected through, for example, a bus 18.

The processor 11 is a computer such as a Central Processing Unit (CPU), and controls the entire information processing device 100 by executing a program prepared in advance. Specifically, as the processor 11, a CPU, a Graphics Processing Unit (GPU), a Digital Signal Processor (DSP), a Micro Processing Unit (MPU), a Floating Processing Unit (FPU), a Physics Processing unit (PPU), a Tensor Processing Unit (TPU), a quantum processor, a microcontroller, or a combination of these can be used.

The processor 11 loads a program stored in the ROM 13 or the recording medium 16 into the RAM 14 and executes each type of processing coded in the program. The processor 11 functions as a part or all of the information processing device 100. Specifically, the processor 11 executes classification processing to be described later.

The IF 12 transmits and receives data to and from an external device. Specifically, the information processing device 100 receives a text group and visual information through the IF 12. The information processing device 100 outputs a classification result of the visual information to a display device or another external device through the IF 12.

The ROM 13 stores various programs executed by the processor 11. The RAM 14 is used as a working memory during execution of various types of processing by the processor 11.

The DB 15 stores various algorithms, data, machine learning models, or the like used when the information processing device 100 executes the classification processing to be described later.

The recording medium 16 is a non-volatile non-transitory recording medium such as a disk-shaped recording medium or a semiconductor memory. The recording medium 16 may be attachable to and detachable from the information processing device 100. The recording medium 16 records various programs executed by the processor 11.

In addition to the above, the information processing device 100 may include a display device such as a liquid crystal display and an input device such as a keyboard and a mouse. The display device and the input device are used by, for example, an operator of the information processing device 100.

### Functional Configuration

### (Basic Configuration)

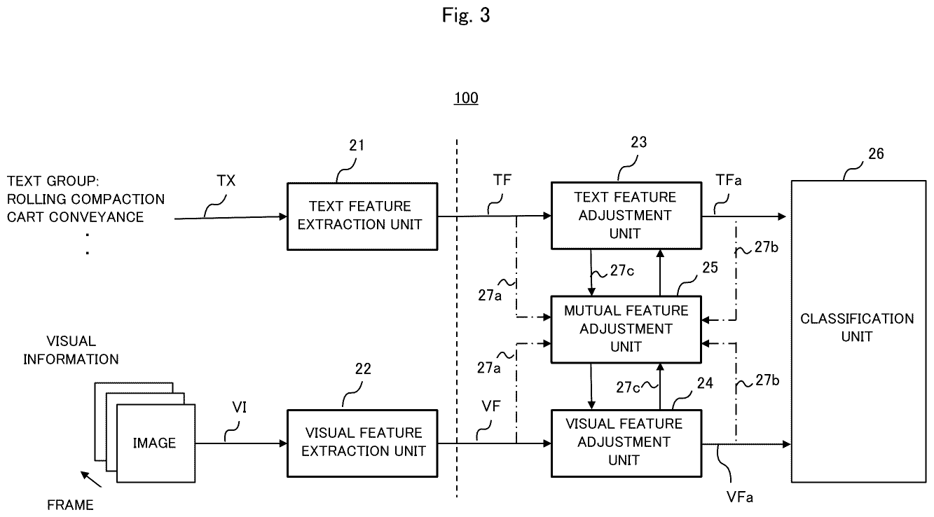

FIG. 3 is a block diagram illustrating a functional configuration of the information processing device 100. As illustrated, the information processing device 100 includes a text feature extraction unit 21, a visual feature extraction unit 22, a text feature adjustment unit 23, a visual feature adjustment unit 24, a mutual feature adjustment unit 25, and a classification unit 26.

The text feature extraction unit 21 receives input of a text group TX. The text group TX includes a plurality of labels related to visual information. For example, in a case where the information processing device 100 classifies work of a person, the text group TX includes labels indicating the work of the person, for example, rolling compaction, cart conveyance, and the like. The text feature extraction unit 21 extracts text features TF from each of a plurality of texts included in the text group TX, and outputs the text features TF as a text feature group TF to the text feature adjustment unit 23. The text features are feature values extracted from text data, and include a vector obtained by quantifying a text. Examples of the text features include Bag of Words (BoW), Term Frequency-Inverse Document Frequency (TF-IDF), and word embedding. A foundation model trained in advance is used as the text feature extraction unit 21, and the text feature extraction unit 21 is not to be trained in the present example embodiment.

The visual feature extraction unit 22 extracts visual features VF from visual information VI. The visual information VI includes an image (still image) or a moving image (video). The visual feature extraction unit 22 extracts visual features from frame images constituting the visual information VI, and outputs the visual features to the visual feature adjustment unit 24 as the visual features VF. The visual features are feature values representing the image or the video in a numerical format. Examples of the visual features include a feature vector generated by a Convolutional Neural Network (CNN), VGG, ResNet, and the like. A foundation model trained in advance is used as the visual feature extraction unit 22, and the visual feature extraction unit 22 is not to be trained in the present example embodiment.

The text feature adjustment unit 23 acquires the text feature group TF from the text feature extraction unit 21, and adjusts the text feature group TF. Specifically, the text feature adjustment unit 23 embeds the text feature group TF in a feature space. At that time, the text feature adjustment unit 23 performs feature alignment in the feature space. The “feature alignment” refers to aligning (performing alignment of) features having different distributions and formats in the same feature space. Specifically, the text feature adjustment unit 23 adjusts a position of each text feature in the feature space. The text feature adjustment unit 23 performs feature alignment of each text feature, and outputs a text feature group TFa obtained by the feature alignment to the mutual feature adjustment unit 25 and the classification unit 26.

The visual feature adjustment unit 24 acquires the visual features VF from the visual feature extraction unit 22, and adjusts the visual features VF. Specifically, the visual feature adjustment unit 24 embeds the visual features VF in the same feature space in which the text features TF are embedded. That is, the text features TF and the visual features VF are embedded in the common feature space. At that time, the visual feature adjustment unit 24 adjusts positions of the visual features VF in the feature space. That is, the visual feature adjustment unit 24 performs feature alignment of the visual features, and outputs visual features VFa obtained by the feature alignment to the mutual feature adjustment unit 25 and the classification unit 26.

The mutual feature adjustment unit 25 acquires the text feature group TF from the text feature adjustment unit 23, and acquires the visual features VF from the visual feature adjustment unit 24. The mutual feature adjustment unit 25 then performs feature alignment of the text feature group TF and the visual features VF based on a mutual relationship between the text feature group TF and the visual features VF. The “mutual relationship” is a concept indicating how feature values are related to each other, and specifically refers to a dependence relationship and a correlation between the feature values, a pattern common between the feature values, presence or absence of such a pattern, and the like. The mutual feature adjustment unit 25 performs the feature alignment between the text feature group TF and the visual features VF by generating feature alignment information indicating the mutual relationship between the text feature group TF and the visual features VF and applying the generated feature alignment information to the text feature group TF and the visual features VF. The feature alignment by the mutual feature adjustment unit 25 is also referred to as “mutual feature alignment”. That is, the “mutual feature alignment” refers to the feature alignment between the text features and the visual features. The mutual feature adjustment unit 25 outputs the text feature group TF obtained by the mutual feature alignment to the text feature adjustment unit 23, and outputs the visual features VF obtained by the mutual feature alignment to the visual feature adjustment unit 24.

It is sufficient that the mutual feature adjustment unit 25 receives the input to or the output from the text feature adjustment unit 23 and the visual feature adjustment unit 24, or the intermediate features in the text feature adjustment unit 23 and the visual feature adjustment unit 24 from those units. That is, in a first example, as indicated by an arrow 27a in FIG. 3, the input to the text feature adjustment unit 23 and the input to the visual feature adjustment unit 24 are input to the mutual feature adjustment unit 25. In a second example, as indicated by an arrow 27b in FIG. 3, the output of the text feature adjustment unit 23 and the output of the visual feature adjustment unit 24 are input to the mutual feature adjustment unit 25. In a third example, as indicated by an arrow 27c in FIG. 3, the intermediate features of the text feature adjustment unit 23 and the intermediate features of the visual feature adjustment unit 24 are input to the mutual feature adjustment unit 25. The “intermediate features” refer to features obtained inside a machine learning model or a deep learning model, and specifically, are feature values extracted in a process in which data passes through a plurality of layers in those models. Here, the output from any of intermediate layers in models constituting the text feature adjustment unit 23 and the visual feature adjustment unit 24 is used as the intermediate features.

The text feature adjustment unit 23 outputs the text feature group TFa obtained by the feature alignment to the classification unit 26. The visual feature adjustment unit 24 outputs the visual features VFa obtained by the feature alignment to the classification unit 26.

The classification unit 26 classifies the visual information by using the text feature group TFa input from the text feature adjustment unit 23 and the visual features VFa input from the visual feature adjustment unit 24. Specifically, the classification unit 26 classifies the visual information into one of the plurality of texts based on similarity between the plurality of text features included in the text feature group TFa and the visual features, that is, a distance in the feature space.

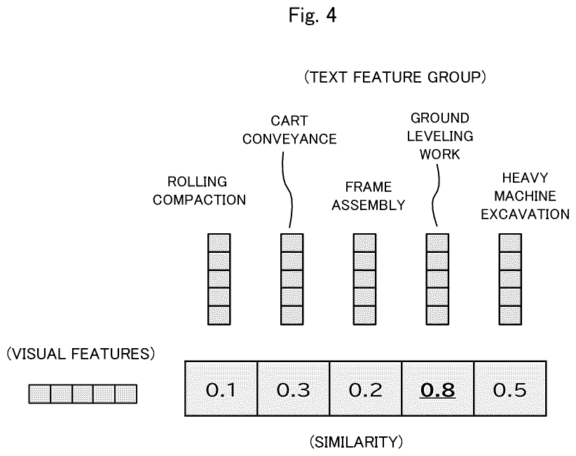

FIG. 4 illustrates an example of the classification by the classification unit 26. Now, it is assumed that an image or a video obtained by capturing a work of a person at a work site is input as the visual information. It is also assumed that five texts indicating the work of the person, that is, “rolling compaction”, “cart conveyance”, “frame assembly”, “ground leveling work”, and “heavy machine excavation” are input as the text group. In this case, the classification unit 26 calculates similarity between visual features and text features of the five texts, and determines a text having the highest similarity (“ground leveling work” in the example of FIG. 4) as a text related to the visual information.

### (Variations of Feature Adjustment Block)

The text feature adjustment unit 23, the visual feature adjustment unit 24, and the mutual feature adjustment unit 25 (hereinafter, those three units are collectively referred to as a “feature adjustment block”) can be configured as follows.

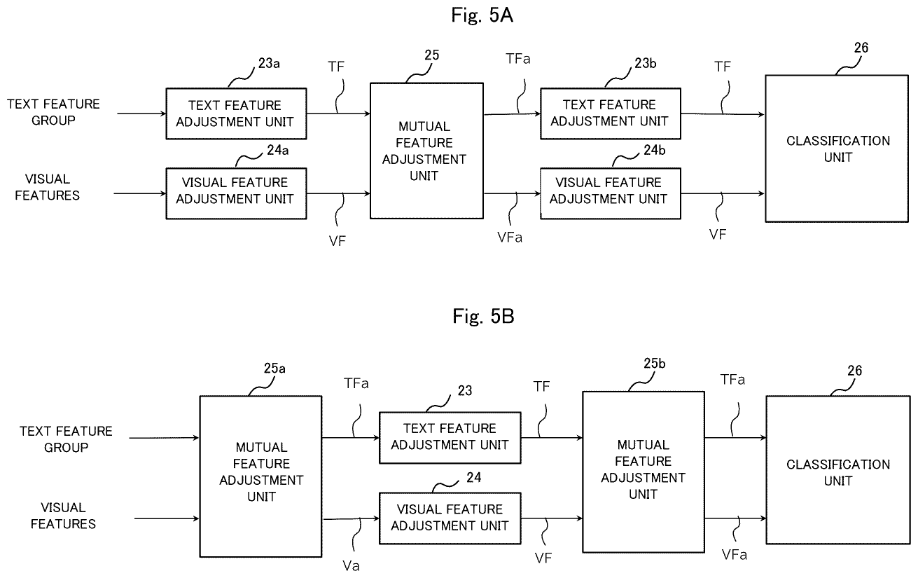

FIG. 5A illustrates a block diagram of a first variation of the feature adjustment block. In the first variation, the mutual feature adjustment unit 25 is arranged at a subsequent stage of a text feature adjustment unit 23a and a visual feature adjustment unit 24a, and a text feature adjustment unit 23b and a visual feature adjustment unit 24b are further arranged at a subsequent stage of the mutual feature adjustment unit 25. As a result, text features are adjusted in three stages of the text feature adjustment unit 23a, the mutual feature adjustment unit 25, and the text feature adjustment unit 23b. Similarly, visual features are adjusted in three stages of the visual feature adjustment unit 24a, the mutual feature adjustment unit 25, and the visual feature adjustment unit 24b. The text feature adjustment units 23a and 23b are networks having the same configuration but different parameters. The visual feature adjustment units 24a and 24b are also networks having the same configuration but different parameters.

FIG. 5B illustrates a block diagram of a second variation of the feature adjustment block. In the second variation, the text feature adjustment unit 23 and the visual feature adjustment unit 24 are arranged between two mutual feature adjustment units 25a and 25b. As a result, text features are adjusted in three stages of the mutual feature adjustment unit 25a, the text feature adjustment unit 23, and the mutual feature adjustment unit 25b. Similarly, visual features are adjusted in three stages of the mutual feature adjustment unit 25a, the visual feature adjustment unit 24, and the mutual feature adjustment unit 25b. The mutual feature adjustment units 25a and 25b are networks having the same configuration but different parameters.

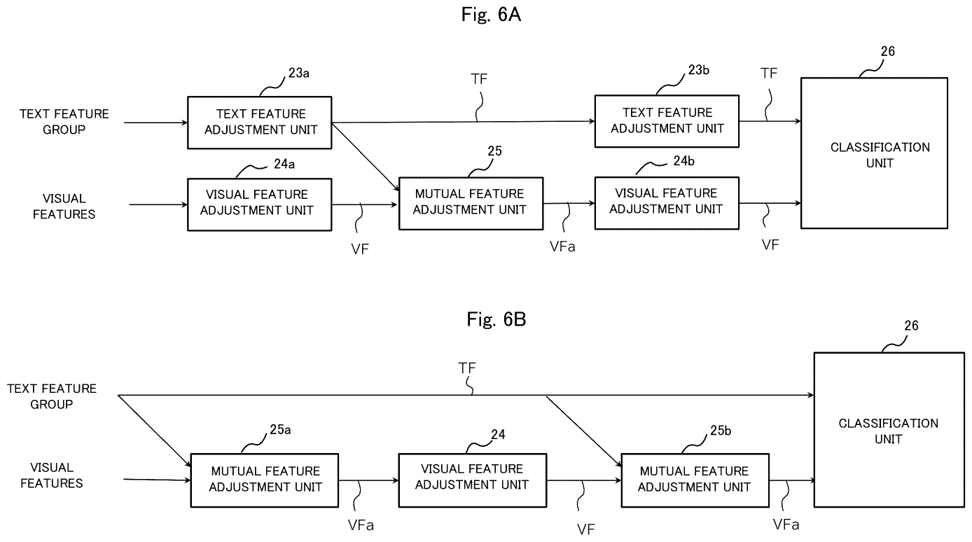

FIG. 6A illustrates a block diagram of a third variation of the feature adjustment block. In the third variation, the mutual feature adjustment unit 25 adjusts visual features but does not adjust text features. That is, the text features are adjusted in two stages of the text feature adjustment unit 23a and the text feature adjustment unit 23b. On the other hand, the visual features are adjusted in three stages of the visual feature adjustment unit 24a, the mutual feature adjustment unit 25, and the visual feature adjustment unit 24b. The text feature adjustment units 23a and 23b are networks having the same configuration but different parameters. The visual feature adjustment units 24a and 24b are also networks having the same configuration but different parameters.

FIG. 6B illustrates a block diagram of a fourth variation of the feature adjustment block. In the fourth variation, text features are not adjusted. On the other hand, visual features are adjusted in three stages of the mutual feature adjustment unit 25a, the visual feature adjustment unit 24, and the mutual feature adjustment unit 25b. The mutual feature adjustment units 25a and 25b are networks having the same configuration but different parameters.

### (Mutual Feature Adjustment Unit)

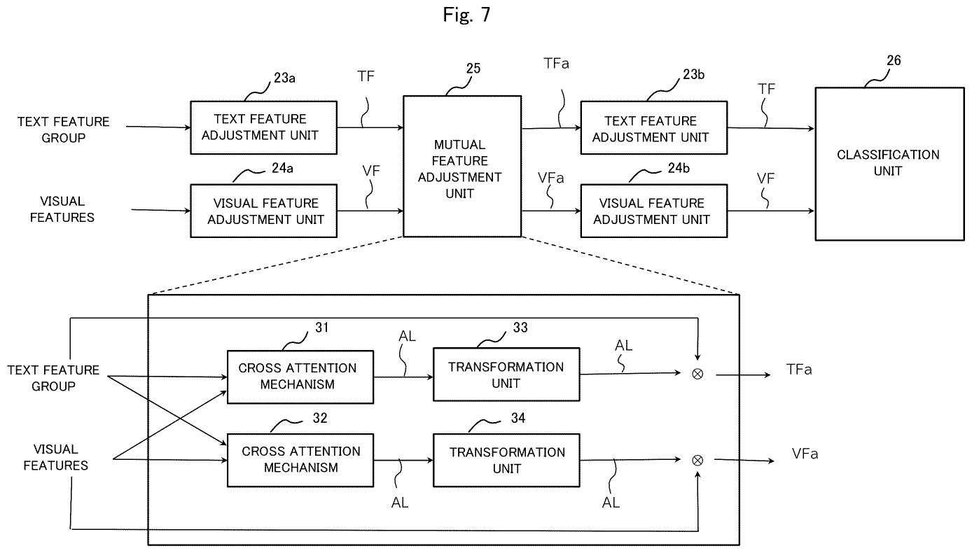

Next, the mutual feature adjustment unit 25 will be described in detail. The mutual feature adjustment unit 25 generates the feature alignment information based on the mutual relationship between the text features and the visual features. FIG. 7 illustrates an example of the mutual feature adjustment unit 25. FIG. 7 illustrates a configuration in which the mutual feature adjustment unit 25 is sandwiched between the text feature adjustment units 23a and 23b and the visual feature adjustment units 24a and 24b, as illustrated in FIG. 6A, but the feature adjustment units may have another configuration.

As illustrated, the mutual feature adjustment unit 25 includes cross attention mechanisms 31 and 32 and transformation units 33 and 34. The cross attention mechanisms 31 and 32 calculate the mutual relationship between the text feature group and the visual features, and output the mutual relationship to each of the transformation units 33 and 34 as feature alignment information AL. The transformation units 33 and 34 perform predetermined transformation on the input feature alignment information AL. The mutual feature adjustment unit 25 further combines the feature alignment information AL obtained by the transformation by the transformation unit 33 with the text feature group, and outputs the text features TFa obtained by the feature alignment. The mutual feature adjustment unit 25 also combines the feature alignment information AL obtained by the transformation by the transformation unit 34 with the visual features, and outputs the visual features VFa obtained by the feature alignment.

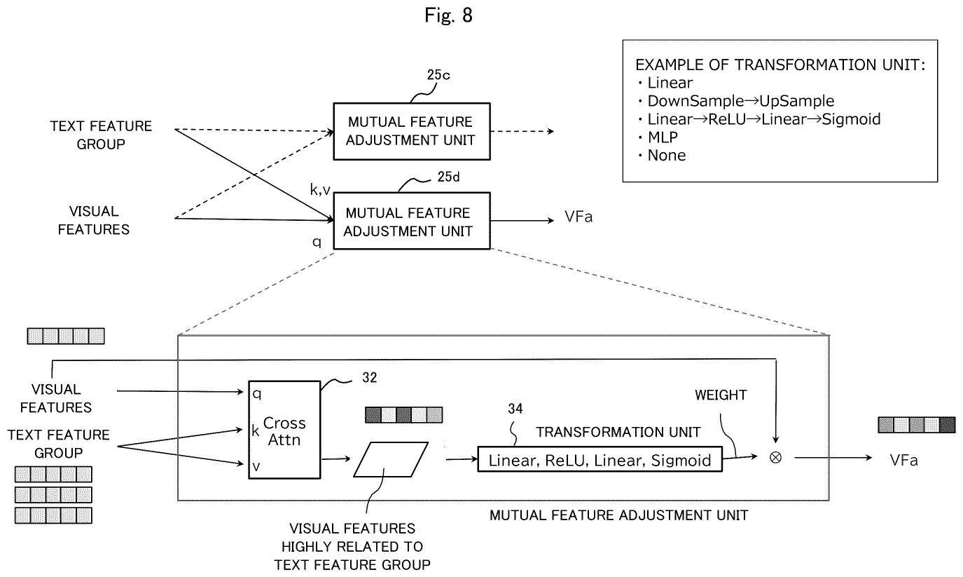

FIG. 8 is a block diagram illustrating a specific example of the mutual feature adjustment unit 25. As illustrated, the mutual feature adjustment unit 25 includes a mutual feature adjustment unit 25c that performs the feature alignment of the text features and a mutual feature adjustment unit 25d that performs the feature alignment of the visual features. FIG. 8 illustrates an internal configuration of the mutual feature adjustment unit 25d for convenience of description. The mutual feature adjustment unit 25d includes the cross attention mechanism 32 and the transformation unit 34. The cross attention mechanism 32 receives the input of the visual features as a query q, and the input of the text feature group as a key k and a value v. The cross attention mechanism 32 extracts visual features highly related to the text feature group, and outputs the visual features to the transformation unit 34. The transformation unit 34 includes, for example, a linear function, an activation function, or the like, and transforms the text features output from the cross attention mechanism 32 into a weight indicating a degree of relevance. This weight is an example of the feature alignment information. Then, by combining this weight with the visual features, the mutual feature adjustment unit 25d outputs the visual features VFa obtained by the feature alignment.

The mutual feature adjustment unit 25c related to the text feature group basically has a configuration similar to that of the mutual feature adjustment unit 25d. However, in the cross attention mechanism 31 of the mutual feature adjustment unit 25c, the text feature group is input as the query q, and the visual features are input as the key k and the value v. The transformation unit 33 related to the text feature group is similar to the transformation unit 34 related to the visual features. It can be assumed that the transformation units 33 and 34 perform one of the following transformation, for example.
Linear transformation
Downsampling→upsampling
Linear transformation→Rectified linear unit (ReLU) function→Linear transformation→Sigmoid function
Multilayer perceptron (MLP)
No transformation

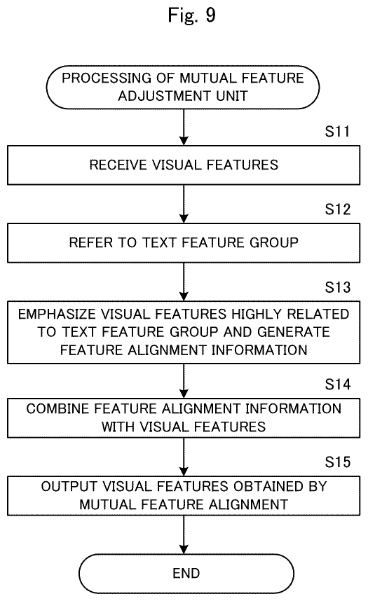

FIG. 9 illustrates a flowchart of processing by the mutual feature adjustment unit 25. The processing in the flowchart of FIG. 9 is performed by the mutual feature adjustment unit 25d related to the visual features illustrated in FIG. 8 in the configuration illustrated in FIG. 7. First, the mutual feature adjustment unit 25d receives the visual features from the visual feature adjustment unit 24a (step S11). Next, the mutual feature adjustment unit 25d refers to the text feature group received from the text feature adjustment unit 23a by the cross attention mechanism 32 (step S12), emphasizes the visual features highly related to the text feature group, and generates the feature alignment information (step S13). The mutual feature adjustment unit 25d then combines the feature alignment information with the visual features (step S14), and outputs the obtained visual features as the visual features VFa obtained by the mutual feature alignment (step S15).

Processing of the mutual feature adjustment unit 25c related to the text features illustrated in FIG. 8 is basically similar. However, the mutual feature adjustment unit 25c acquires the text features in step S11, emphasizes the text feature group highly related to the visual features and generates the feature alignment information in steps S12 and S13, and combines the feature alignment information with the text features in step S14.

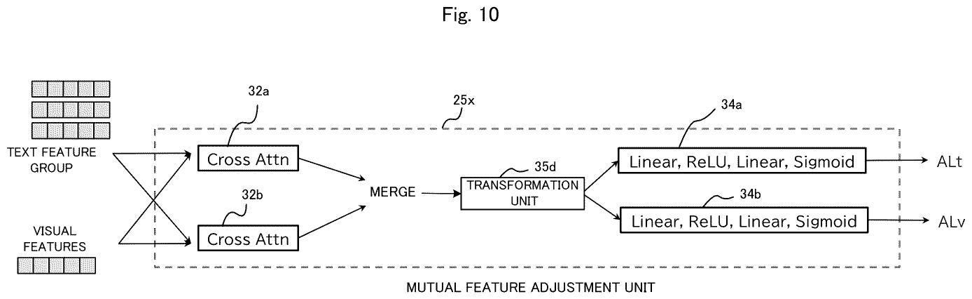

Next, variations of the mutual feature adjustment unit 25 will be described. FIG. 10 illustrates a functional configuration of a mutual feature adjustment unit 25x according to a first variation. In FIG. 10, a cross attention mechanism 32a is the same as the cross attention mechanism 32 included in the mutual feature adjustment unit 25d in FIG. 8. A cross attention mechanism 32b is similar to a cross attention mechanism included in the mutual feature adjustment unit 25c in FIG. 8, and the text feature group is input to the query q, and the visual features are input to the key k and the value v. In the first variation, the mutual feature adjustment unit 25x merges the output of the cross attention mechanism 32a related to the text feature group and the output of the cross attention mechanism 32b related to the visual features, and inputs the merged output to a transformation unit 35d. The merging is performed by, for example, averaging, adding, or pooling.

The transformation unit 35 includes a network having learnable parameters. The output of the transformation unit 35 is input to a transformation unit 34a related to the text feature group and a transformation unit 34b related to the visual features. The transformation units 34a and 34b are the same as the transformation unit 34 illustrated in FIG. 8. The transformation unit 34a generates alignment information ALt related to the text feature group based on the output from the transformation unit 35. The transformation unit 34b generates alignment information ALv related to the visual features based on the output from the transformation unit 35.

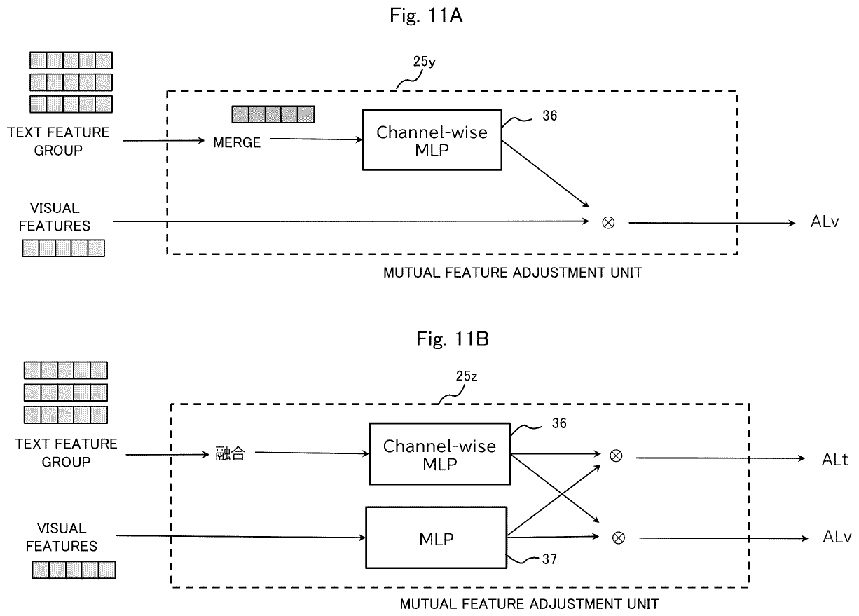

FIG. 11A illustrates a functional configuration of a mutual feature adjustment unit 25y according to a second variation. The mutual feature adjustment unit 25y according to the second variation merges the text feature group into one text feature. The merging is performed by, for example, averaging, adding, or pooling. The merged text feature is input to a channel-wise MLP 36. The channel-wise MLP is a fully connected layer that performs processing for each channel, and performs processing for each channel on the merged text feature and outputs the text feature subjected to the processing. By combining the output of the channel-wise MLP 36 with the visual features, the mutual feature adjustment unit 25y generates the alignment information ALv related to the visual features.

FIG. 11B illustrates a functional configuration of a mutual feature adjustment unit 25z according to a third variation. The mutual feature adjustment unit 25z according to the third variation also merges the text feature group into one text feature. The merged text feature is input to the channel-wise MLP 36. The channel-wise MLP is a fully connected layer that performs processing for each channel, and performs processing for each channel on the merged text feature and outputs the text feature subjected to the processing. On the other hand, the visual features are input to an MLP 37. By combining the output of the channel-wise MLP 36 and the output of the MLP 37, the mutual feature adjustment unit 25z generates the alignment information ALt related to the text feature and the alignment information ALv related to the visual features.

### (Configuration at the Time of Training)

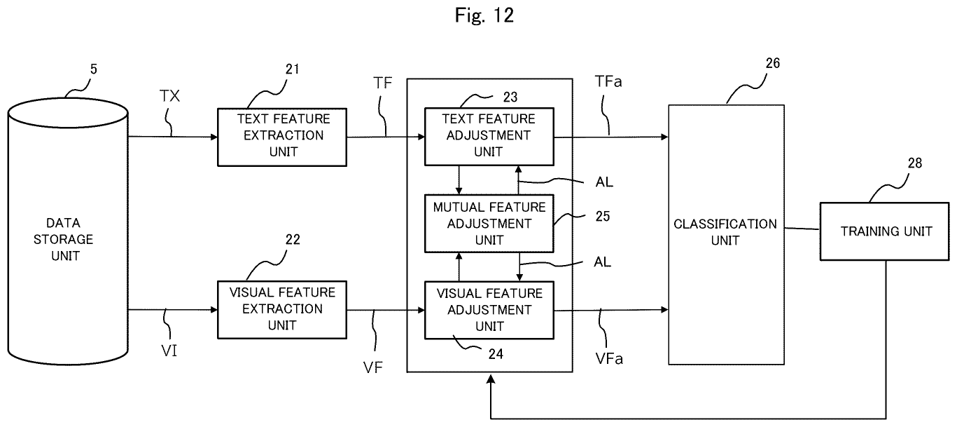

Next, a configuration of the information processing device 100 at the time of training will be described. FIG. 12 illustrates the configuration of the information processing device 100 at the time of training. In the example of FIG. 12, it is assumed that the mutual feature adjustment unit 25 performs the mutual feature alignment by using the intermediate features of the text feature adjustment unit 23 and the visual feature adjustment unit 24.

An information processing device 100x at the time of training includes a data storage unit 5 that stores training data and a training unit 28, in addition to the components at the time of inference illustrated in FIG. 3. The data storage unit 5 stores, as the training data, the pieces of visual information (images or videos) to be classified and the text group that is ground truth information related to those. At the time of training, the visual information VI included in the training data is input to the visual feature extraction unit 22, and the text group TX that is ground truth information for the visual information is input to the text feature extraction unit 21.

The text feature extraction unit 21 extracts the text features from each of texts included in the text group TX, and outputs the text features as the text feature group TF to the text feature adjustment unit 23. The visual feature extraction unit 22 extracts the visual features VF from the visual information VI, and outputs the extracted visual features VF to the visual feature adjustment unit 24. The mutual feature adjustment unit 25 generates the feature alignment information indicating the mutual relationship between the text feature group and the visual features based on the intermediate features of the text feature group acquired from the text feature adjustment unit 23 and the intermediate features of the visual features acquired from the visual feature adjustment unit 24, and outputs the feature alignment information to the text feature adjustment unit 23 and the visual feature adjustment unit 24.

The text feature adjustment unit 23 performs the feature alignment of the text feature group by using the input feature alignment information, and outputs the text features TFa obtained by the feature alignment to the classification unit 26. The visual feature adjustment unit 24 performs the feature alignment of the visual features by using the input feature alignment information, and outputs the visual features VFa obtained by the feature alignment to the classification unit 26. The classification unit 26 classifies the visual features VFa based on similarity between the visual features VFa and the text feature group TFa, and outputs a classification result to the training unit 28.

The training unit 28 optimizes the text feature adjustment unit 23, the visual feature adjustment unit 24, and the mutual feature adjustment unit 25 based on the classification result. Specifically, the training unit 28 optimizes parameters of a network constituting the text feature adjustment unit 23, the visual feature adjustment unit 24, and the mutual feature adjustment unit 25. In this manner, at the time of training, the text feature adjustment unit 23, the visual feature adjustment unit 24, and the mutual feature adjustment unit 25 are optimized by using the training data. In this manner, the information processing device 100 trained in advance is obtained.

### Classification Processing

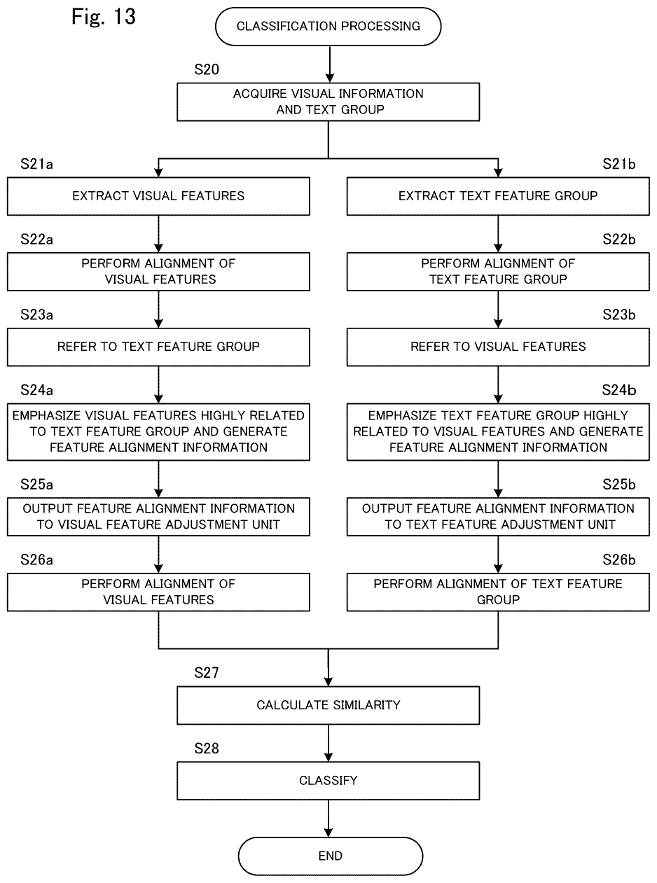

Next, the classification processing by the above information processing device 100 will be described. FIG. 13 is a flowchart of the classification processing. This processing is achieved by the processor 11 illustrated in FIG. 2 executing a program prepared in advance and operating as each component illustrated in FIG. 3 and the like.

First, the information processing device 100 acquires the visual information VI and the text group TX (step S20). Next, the information processing device 100 executes processing of the visual information and processing of the text group in parallel. First, the processing of the visual information will be described.

The visual feature extraction unit 22 extracts the visual features VF from the visual information VI (step S21a). Next, the visual feature adjustment unit 24 performs the feature alignment of the visual features (step S22a). Next, the mutual feature adjustment unit 25 refers to the text feature group (step S23a), emphasizes the visual features highly related to the text feature group and generates the feature alignment information (step S24a), and outputs the feature alignment information to the visual feature adjustment unit 24 (step S25a). Next, the visual feature adjustment unit 24 performs the feature alignment of the visual features VF by using the input feature alignment information, and outputs the visual features VFa obtained by the feature alignment to the classification unit 26 (step S26a).

Next, the processing of the text group will be described. The processing of the text group is basically similar to the processing of the visual information. First, the text feature extraction unit 21 extracts the text feature group TF from the text group TX (step S21b). Next, the text feature adjustment unit 23 performs the feature alignment of the text feature group TF (step S22b). Next, the mutual feature adjustment unit 25 refers to the visual features (step S23b), emphasizes the text feature group highly related to the visual features and generates the feature alignment information (step S24b), and outputs the feature alignment information to the text feature adjustment unit 23 (step S25b). Next, the text feature adjustment unit 23 performs the feature alignment of the text feature group TF by using the input feature alignment information, and outputs the text feature group TFa obtained by the feature alignment to the classification unit 26 (step S26b).

Next, the classification unit 26 calculates the similarity between the input visual features VFa and each text feature included in the input text feature group TFa (step S27), and classifies the visual information (step S28). Specifically, the classification unit 26 determines a text with a text feature having the highest similarity to the visual features as the text related to the visual information. The classification unit 26 may output a plurality of texts as the classification results in descending order of the similarity. Then, the classification processing ends.

### Verification Result

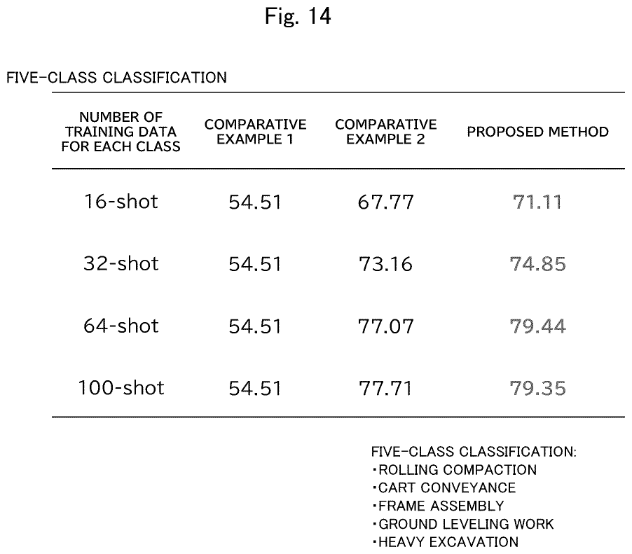

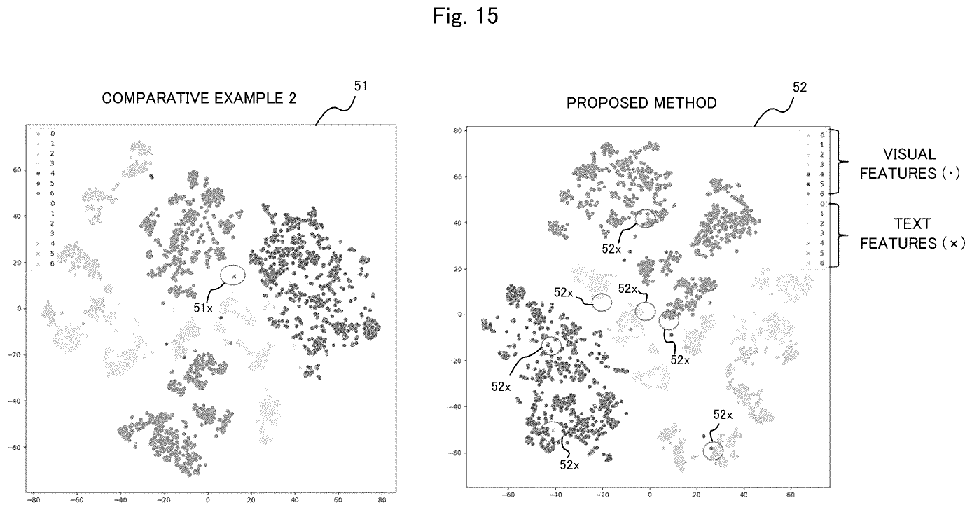

Next, a verification result of the classification processing by the information processing device 100 of the present example embodiment will be described. FIG. 14 illustrates a result of five-class classification by the information processing device 100. The “number of pieces of training data for each class” is the number of pieces of training data of each class used at the time of training. “Comparative Example 1” indicates an example in which the feature alignment is not performed on the visual features and the text feature group. That is, Comparative Example 1 indicates a case where the text feature adjustment unit 23, the visual feature adjustment unit 24, and the mutual feature adjustment unit 25 are omitted in FIG. 3, and the classification unit 26 performs classification based on the text feature group TF and the visual features VF. “Comparative Example 2” indicates an example in which the feature alignment is independently performed on the visual features and the text feature group but the mutual feature alignment is not performed. That is, Comparative Example 2 indicates a case where the mutual feature adjustment unit 25 is omitted in FIG. 3, and the classification unit 26 performs classification based on the text feature group TFa and the visual features VFa.

As understood from FIG. 14, accuracy of the proposed method exceeds accuracy of Comparative Examples 1 and 2 in any case of the number of pieces of training data. In this manner, in the method of the present example embodiment, it is possible to perform classification with higher accuracy by performing the mutual feature alignment between the text feature group and the visual features.

FIG. 15 illustrates feature maps representing distributions of features on the feature space in the above Comparative Example 2 and proposed method. A feature map 51 is the feature map of Comparative Example 2, and a feature map 52 is the feature map of the proposed method. In each feature map, a dot (·) indicates the visual feature, and a cross (×) indicates the text feature. This example is an example of seven-class classification, and each of classes (0 to 6) in the feature map is displayed using a different color.

In the feature map 51 of Comparative Example 2, the dots indicating the visual features are distributed with a certain degree of aggregation for each class. On the other hand, the crosses indicating the text features are concentrated at substantially the same position. That is, in this example, the crosses for seven classes are at substantially the same position (see a circle 51x) and overlap. In this manner, it can be seen that image features and the text features are independently aligned in the feature space in Comparative Example 2.

Also in the feature map 52 of the proposed method, the dots indicating the visual features are distributed with a certain degree of aggregation for each class. The crosses indicating the text features are distributed in a form related to the aggregation of the visual features related to each class, as indicated by individual circles 52x. That is, according to the proposed method, the image features and the text features are aligned according to a mutual relationship between them. In this manner, in the method of the present example embodiment, the feature alignment in consideration of the mutual relationship between the image features and the text features can be performed.

### Application Example

The information processing device of the present disclosure can be applied to, for example, action management of a person, a robot, or the like in an industrial site or the like. Specifically, the method of the present disclosure can be used for automation of warehouses in a distribution industry, efficiency improvement of stores in a retail industry, efficiency improvement of site management in a construction industry, automation of inspections in a manufacturing industry, or the like.

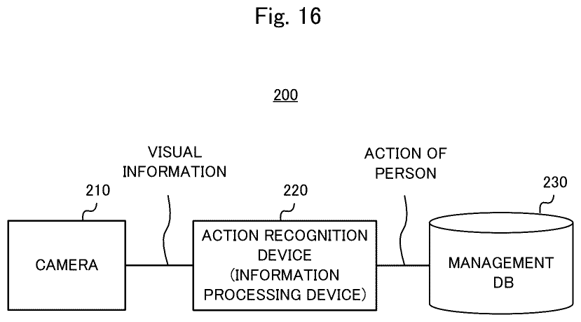

FIG. 16 illustrates an example of an action management system to which the information processing device of the present disclosure is applied. An action management system 200 includes a camera 210, an action recognition device 220, and a management DB 230. The camera 210 is installed at a site to be managed, captures an image, a video, and the like of the site, and transmits the image, the video, and the like to the information processing device 100. The action recognition device 220 is configured using the above information processing device 100, and classifies and recognizes an action or work of a person working on the site based on visual information obtained by the camera 210. The action recognition device 220 then associates the recognized action of each person with time, a position at the site, or the like, and records the action in the management DB 230 as an action history. As a result, a manager at the site can manage workers based on the action history of each person recorded in the management DB 230.

### Second Example Embodiment

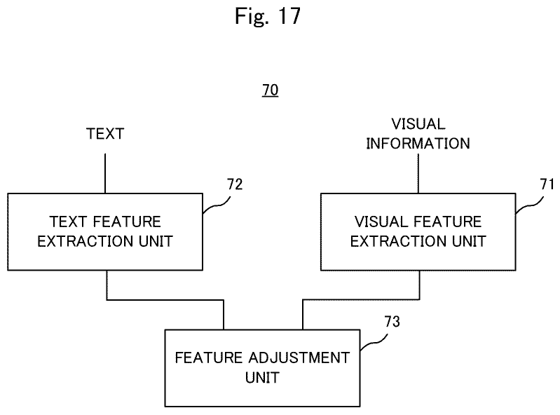

FIG. 17 is a block diagram illustrating a functional configuration of an information processing device according to another example of the present disclosure. An information processing device 70 includes a visual feature extraction unit 71, a text feature extraction unit 72, and a feature adjustment unit 73.

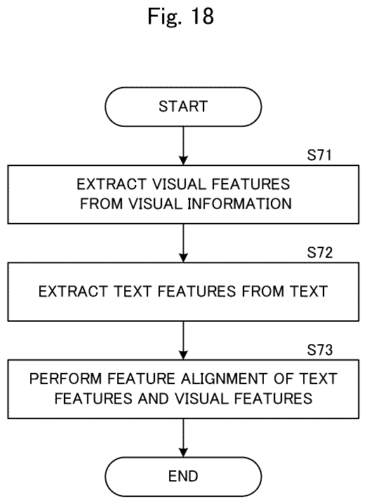

FIG. 18 is a flowchart of processing by the information processing device 70. The visual feature extraction unit 71 extracts visual features from object visual information (step S71). The text feature extraction unit 72 extracts text features from a text related to the visual features (step S72). The feature adjustment unit 73 performs feature alignment of the text features and the visual features based on a mutual relationship between the text features and the visual features (step S73).

Some or all of the above example embodiments can also be described as the following Supplementary Notes, but are not limited to the following Supplementary Notes.

### Supplementary Note 1

An information processing device comprising:
a visual feature extraction means configured to extract visual features from visual information;
a text feature extraction means configured to extract text features from a text related to the visual features; and
a feature adjustment means configured to perform feature alignment of the text features and the visual features based on a mutual relationship between the text features and the visual features.

### Supplementary Note 2

The information processing device according to Supplementary note 1, wherein the feature adjustment means adjusts the text features and the visual features in a same feature space.

### Supplementary Note 3

The information processing device according to Supplementary note 1, wherein the feature adjustment means includes:
a text feature adjustment means configured to perform the feature alignment of the text features;
a visual feature adjustment means configured to perform the feature alignment of the visual features; and
a mutual adjustment means configured to reflect feature alignment information for performing the feature alignment based on the mutual relationship between the text features and the visual features on at least one of the text feature adjustment means and the visual feature adjustment means.

### Supplementary Note 4

The information processing device according to Supplementary note 3, wherein the mutual adjustment means determines the mutual relationship between the text features and the visual features based on input of each of the text feature adjustment means and the visual feature adjustment means, output of each of the text feature adjustment means and the visual feature adjustment means, or intermediate features of each of the text feature adjustment means and the visual feature adjustment means.

### Supplementary Note 5

The information processing device according to Supplementary note 3, wherein the mutual adjustment means determines the mutual relationship between the text features and the visual features by using a cross attention mechanism, and generates the feature alignment information.

### Supplementary Note 6

The information processing device according to Supplementary note 1, wherein the text feature extraction means generates the text feature by merging features extracted from a plurality of texts.

### Supplementary Note 7

The information processing device according to Supplementary note 1, further comprising classification means for classifying the visual information into one of a plurality of texts based on similarity between the text features obtained by the feature alignment and the visual features obtained by the feature alignment.

### Supplementary Note 8

The information processing device according to Supplementary note 7, wherein the visual information is information obtained by capturing an action state of a person,
wherein the text indicates an action of the person, and
wherein the classification means recognizes the action of the person included in the visual information.

### Supplementary Note 9

An information processing method executed by a computer, the information processing method comprising:
extracting visual features from visual information;
extracting text features from a text related to the visual features; and
performing feature alignment of the text features and the visual features based on a mutual relationship between the text features and the visual features.

### Supplementary Note 10

A program for causing a computer to execute processing comprising:
extracting visual features from visual information;
extracting text features from a text related to the visual features; and
performing feature alignment of the text features and the visual features based on a mutual relationship between the text features and the visual features.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Some or all of the configurations described as Supplementary Notes can be similarly dependent on not only Supplementary Notes 1, 9, and 10, but also various pieces of hardware and software, and various recording means or systems for recording software without departing from the above-described example embodiments.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

1 Processor
21 Text feature extraction unit
22 Visual feature extraction unit
23 Text feature adjustment unit
24 Visual feature adjustment unit
25 Mutual feature adjustment unit
26 Classification unit
28 Training unit
100 Information processing device

1. An information processing device comprising:
at least one memory configured to store instructions; and
at least one processor configured to execute the instructions to:
extract visual features from visual information;
extract text features from a text related to the visual features; and
perform feature adjustment of the text features and the visual features based on a mutual relationship between the text features and the visual features.

2. The information processing device according to claim 1, wherein the at least one processor performs the feature adjustment of the text features and the visual features in a same feature space.

3. The information processing device according to claim 1, wherein the at least one processor performs the feature adjustment by:
performing the feature alignment of the text features;
performing the feature alignment of the visual features; and
performing mutual adjustment of reflecting feature alignment information for performing the feature alignment based on the mutual relationship between the text features and the visual features on at least one of the feature alignment of the text features and the feature alignment of the visual features.

4. The information processing device according to claim 3, wherein the at least one processor determines the mutual relationship between the text features and the visual features based on an input to each of the feature alignment of the text features and the feature alignment of the the visual features, an output of each of the feature alignment of the text features and the feature alignment of the the visual features, or intermediate features of each of the feature alignment of the text features and the feature alignment of the the visual features.

5. The information processing device according to claim 3, wherein the at least one processor determines the mutual relationship between the text features and the visual features by using a cross attention mechanism, and generates the feature alignment information.

6. The information processing device according to claim 1, wherein the at least one processor generates the text feature by merging features extracted from a plurality of texts.

7. The information processing device according to claim 1, wherein the at least one processor is further configured to execute the instructions to classify the visual information into one of a plurality of texts based on similarity between the text features obtained by the feature alignment and the visual features obtained by the feature alignment.

8. The information processing device according to claim 7,
wherein the visual information is information obtained by capturing an action state of a person,
wherein the text indicates an action of the person, and
wherein the at least one processor recognizes the action of the person included in the visual information.

9. An information processing method executed by a computer, comprising:
extracting visual features from visual information;
extracting text features from a text related to the visual features; and
performing feature alignment of the text features and the visual features based on a mutual relationship between the text features and the visual features.

10. A non-transitory computer-readable recording medium storing a program, the program causing a computer to execute processing comprising:
extracting visual features from visual information;
extracting text features from a text related to the visual features; and
performing feature alignment of the text features and the visual features based on a mutual relationship between the text features and the visual features.
